(19) United States
(12) Patent Application Publication
(10) Pub. No.: US 2014/0339043 A1
(43) Pub. Date: Nov. 20, 2014

(54) CLUTCH ASSEMBLY

(71) Applicants: Szuba Consulting, Inc., Dearborn, MI (US); Value Extraction LLC, Dearborn, MI (US)

(72) Inventor: Joseph Szuba, Dearborn, MI (US)

(21) Appl. No.: 14/450,822

(22) Filed: Aug. 4, 2014

Related U.S. Application Data
(63) Continuation-in-part of application No. 14/074,644, filed on Nov. 7, 2013.
(60) Provisional application No. 61/723,483, filed on Nov. 7, 2012.

(51) Int. Cl. F16D 13/52

(52) U.S. Cl. CPC F16D 13/52
USPC 192/70.2

(57) ABSTRACT

A clutch assembly including a housing having internal radial teeth including relatively sharp V-shaped crests and troughs and annular clutch plates having teeth of the same configuration, wherein the included angle between adjacent teeth is about 60°. The internal surface of the housing in the disclosed embodiment further includes generally straight segments between a plurality of adjacent teeth having a longitudinal oil slot. The radial teeth of the clutch plates are continuous to nest into the internal teeth of the housing and the relatively straight segments.

### PRIOR APPLICATIONS

This application is a Continuation-in-Part application of Ser. No. 14/074,644 filed Nov. 7, 2013, which application claims priority to U.S. Provisional Patent Application No. 61/723,483, filed Nov. 7, 2012.

### BACKGROUND

This application relates to a clutch assembly, particularly including an automotive clutch assembly used in automotive transmissions for transferring motive or torsional force between components of a vehicle which has been used for many years. A clutch assembly generally includes a number of annular clutch plates received by a clutch housing which are disposed in driven engagement with an annular wall of clutch housing. A typical clutch housing includes a plurality of internal radial teeth which are truncated or trapezoidal-shaped to provide strength under extreme torsional loads. The housing receives a plurality of annular clutch plates nested within the annular wall of the housing also having external radial teeth which are nested within and engage the internal teeth of the annular housing wall. In a typical application, the annular clutch plates further include internal radial teeth which engage a driveshaft having external teeth or splines. Torsional loads are thus transmitted by the clutch housing assembly. The clutch plates are typically retained in the housing by a snap ring and the clutch plates may be compressed or released depending upon the torsional load. The annular clutch plates typically include a frictional material such that the clutch plates, when compressed against each other, function as a single unit.

There are several problems associated with the present commercial automotive clutch assemblies, particularly with the truncated tooth design. First, the present design of clutch assemblies fail under extreme torsional loads, because the contact areas or drive faces of the engaging teeth of the housing and clutch plates are insufficient for extreme torsional loads, such as trucks carrying heavy loads, backing up or driving up hills. Thus, in an automotive “tow package” additional clutch plates are provided to increase the tooth contact areas. Of course, this adds weight to the assembly and may not be sufficient for extreme torsional loads.

Second, the temperature of the oil or lubricant in the clutch assembly cannot be greater than 210° F. or the lubricant will start to burn, which may destroy the transmission. As will be understood by those skilled in this art, lubricant is pumped through the clutch assembly. However, in conventional clutch assembly designs, the clutch assembly includes very small lubrication channels or ports; however, the small ports are subject to clogging which results in rapid overheating of the assembly.

The disclosed clutch assembly solves these problems by increasing the contact area of the mating teeth of the housing and clutch plates and by providing an enlarged unimpeded flow path for the lubricant.

### SUMMARY OF THE DISCLOSURE

The disclosed clutch assembly includes a housing having a generally cylindrical annular outer wall defined around a central axis including an internal surface having a plurality of circumferentially spaced radial teeth. In the disclosed embodiment, the teeth have a relatively sharp V-shaped crests and a relatively sharp V-shaped troughs and an included angle between adjacent teeth of about sixty degrees. The assembly further includes a plurality of annual clutch plates nested within the annular outer wall of the housing having a plurality of circumferentially spaced external teeth also having a relatively sharp V-shaped crest and a relatively sharp V-shaped trough with an included angle between adjacent teeth of about sixty degrees. This mating tooth configuration substantially increases the contact areas or drive surfaces of the flanks of the teeth and further increases the number of teeth in contact, reducing failure of the clutch assembly the requirement for additional annular clutch plates. In the disclosed embodiment of the clutch assembly, the relatively sharp V-shaped crests and troughs of the teeth include a small rounded end surface avoiding sharp edges and damage or injury during manufacture and use.

Further, in the disclosed embodiment, the internal surface of the outer wall of the housing includes generally straight segments between a plurality of adjacent teeth each having a slot through the annular wall delivering oil through the annular wall significantly improving oil flow through the clutch assembly. In the disclosed embodiment, the slots are relatively long and extend generally parallel to the central axis of the housing and the generally straight segments of the outer wall extend between crest portions of the radial teeth, wherein the straight segments increase the strength of the housing against torsional loads. The plurality of annular clutch plates nested within the outer wall of the housing in the disclosed embodiment each have a continuous plurality of external triannular radial teeth received and nested within the internal radial teeth of the housing and the straight segments between the teeth eliminating problems of alignment during assembly. In the disclosed embodiment, the straight segments are evenly circumferentially spaced about the outer wall and at least three radial teeth are located between each of the relatively straight segments. Thus, the disclosed clutch assembly improves oil flow through the clutch assembly.

In the disclosed embodiment, the annular clutch plates include a thin annular metal plate having the plurality of external teeth and an annular fibrous plate between each of the annular metal plates, such that the clutch plates move in unison upon compression. In the disclosed embodiment, the clutch plates include a fibrous outer layer and a metal core. Further, in the disclosed embodiment, the troughs of the teeth of the housing are tapered toward a distal open end of the housing providing improved oil flow through the housing.

Other advantages and meritorious features of the disclosed clutch assembly will be fully understood from the following detailed description and drawings, a brief description of which follows.

### BRIEF DESCRIPTION OF THE DRAWINGS

FIG. 1 is a cross-sectional view of the disclosed clutch assembly in the direction of view arrows 1-1 in FIG. 2;

FIG. 2 is a top perspective view of one embodiment of a housing of the disclosed clutch assembly;

FIG. 3 is a top view of one embodiment of a clutch plate assembly;

FIG. 4 is a partial top view of the housing shown in FIG. 1 comparing the disclosed housing with a conventional clutch housing;

FIG. 5 is a top perspective view of an alternative embodiment of the disclosed clutch housing; and

FIG. 6 is a side cross-sectional view similar to FIG. 1 illustrating the flow of oil through the housing.

### DETAILED DESCRIPTION

The embodiment of the clutch assembly housing 20 best shown in FIG. 2 includes an annular, generally cylindrical outer wall 22 having an internal surface 24, an external surface 26 and a distal end 28. The housing further includes a radial annular bottom wall 30 as best shown in FIG. 2. The outer wall 22 includes a plurality of V-shaped radial teeth 34 each having planar side faces 36 extending to a relatively sharp V-shaped outer crest portion 38 and an inner relatively sharp V-shaped trough portion. The preferred included angle between the planar side faces 36 of the teeth is preferably about 60° +/−15°, or more preferably 60° +/−5°. However, as shown in FIG. 4, the relatively sharp V-shaped outer crests 38 and troughs 40 include a small rounded surface 42 to avoid cracking or injury from sharp edges during assembly. It has been found that triangular teeth having planar side faces 36 extending to relatively sharp outer crests 38 and relatively sharp troughs 40 having an included angle of about 60° between the planar side faces of the teeth 36 provides a maximum area of the drive faces or contact faces with the teeth of the clutch faces (described below) with greater flexibility, thereby reducing the number of clutch plates required for a particular torsional load and therefore the overall weight of the assembly.

As shown in FIG. 2, this embodiment of the annular wall 22 of the housing 20 further includes a plurality of ccircumferentially spaced generally straight segments 46. Each of the generally straight segments 46 includes an elongated slot 48 through the outer wall 22 delivering oil through the annular wall. In the disclosed embodiment, the elongated slots 48 extend parallel to the central axis of the housing 20 and the generally straight segments 46 extend between the crests 38 of the adjacent teeth, providing an internal chamber 50 for receipt of oil or other lubricant. As will be understood, the generally straight segments, including the radial slots 48, significantly improve the oil flow through the housing, reducing heating of the oil or other lubricant and avoiding fires or damage to the transmission. In the embodiment of the housing 20 shown in FIG. 2, the outer wall 22 includes three fully formed V-shaped radial teeth 34 between each of the circumferentially spaced generally straight segments 46. In fact, however, the radial teeth of the clutch plates engage the inclined surfaces 52 of the generally straight segments, providing additional driving faces. The number of generally straight segments will depend upon the size of the clutch assembly and other factors. As will be understood, the generally straight segments 46 can also be arcuate or cylindrical.

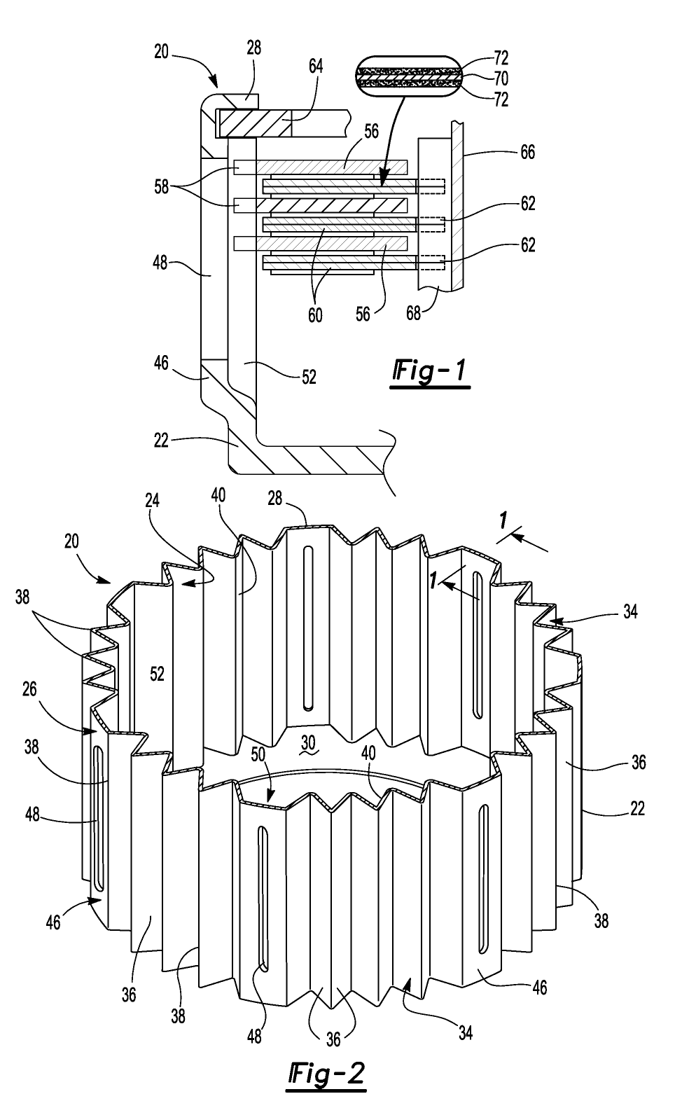

FIG. 1 illustrates one embodiment of a clutch assembly including the housing 20 described above. As shown in FIG. 2, the cross-section is through a generally straight segment 46 of the annular wall having a longitudinally extending radial slot 48. The disclosed embodiment of the clutch assembly further includes a first plurality of annular clutch plates 56 each having a continuous plurality of external triangular radial teeth 58 nested within and engaging the inclined side walls 52 of the annular wall 22 and a second plurality of clutch plates 60 having internal triannular teeth 62. The clutch plates are described in more detail below. The assembly is retained in place by a conventional snap ring 64 and a driveshaft 66 having external radial teeth 68 which intermesh with the internal radial teeth or splines 62 of the second plurality of clutch plates 60.

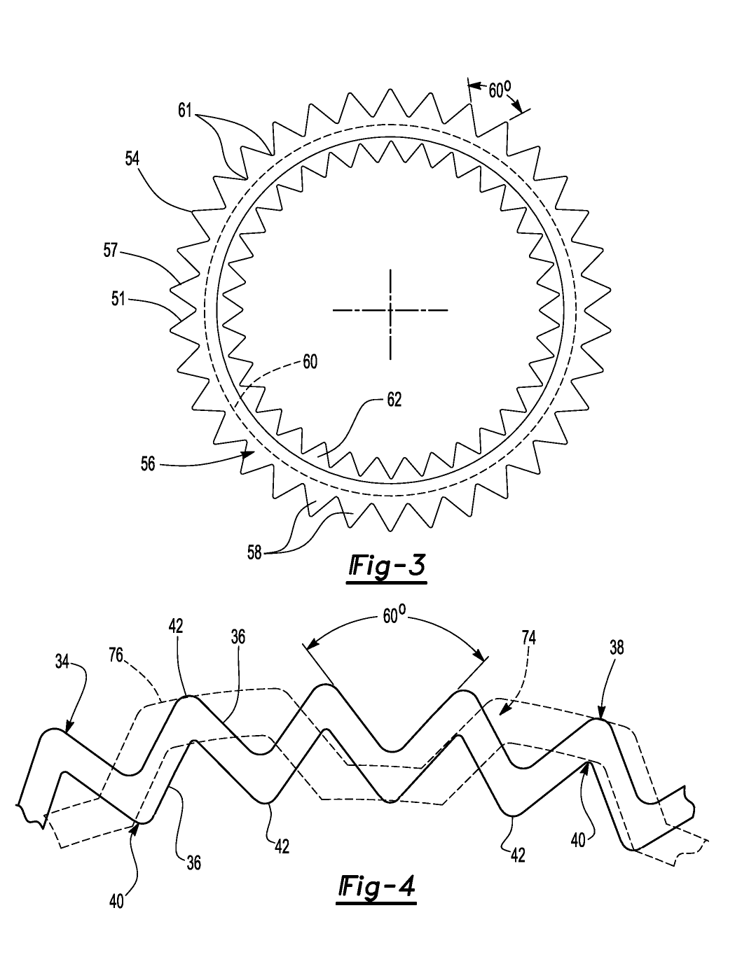

FIG. 3 is a top view of the clutch plates 56 and 60 shown in FIG. 1 and described above. The plurality of clutch plates 56 and 60 are assembled as shown, wherein a first plurality of annular clutch plates 56 include external radial V-shaped teeth 58 are triangular having planar side faces 57 extending to relatively sharp V-shaped crests 59 and relatively sharp V-shaped troughs 61 as described above with regard to the V-shaped radial teeth 34 of the housing, wherein the included angle between adjacent teeth is about 60° as described above. Thus, the external radial teeth 58 of the first plurality of annular clutch plates precisely mesh with the internal surfaces of the V-shaped radial teeth of the annular wall 22 of the housing. Further, as described above, the planar surfaces 57 of the external radial teeth of the clutch plates provide the greatest contact surfaces with the internal planar side faces 36 of the radial teeth 34 of the housing. The radial teeth 62 of the second plurality of clutch plates may be any configuration; however, in one preferred embodiment, the radial teeth 62 of the second plurality of clutch plates 60 have a similar configuration to the radial teeth 58 and the splines of the driveshaft 66 may have a similar configuration. In one preferred embodiment, the second plurality of clutch plates 60 includes a metal core 70 and fibrous outer layer 72 as shown in FIG. 1.

FIG. 4 merely illustrates a plurality of V-shaped radial teeth 34 of the housing 20 described above comparing the radial teeth 34 of this embodiment with the radial teeth 74 (shown in phantom) have a conventional or commercial clutch housing, wherein the teeth 74 are truncated as shown at 76 and the included angle between adjacent teeth is substantially greater than 60°. Thus, the configuration of the teeth 34 of the housing and radial teeth 58 of the first plurality of annular clutch plates 56 results in a greater number of teeth and a significantly greater number of contact faces, resulting in a stronger, improved clutch assembly.

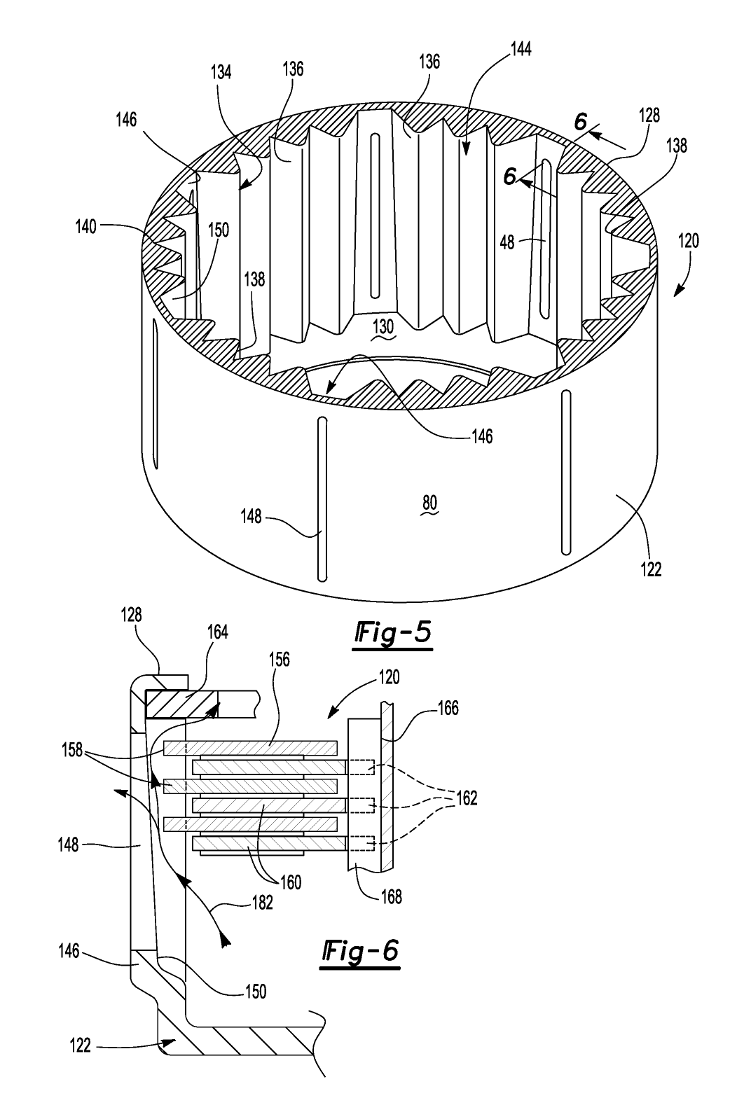

The embodiment of the clutch assembly housing 120 shown in FIG. 5 has a cylindrical outer wall 80. The annular wall 122 includes an internal surface 124 having a plurality of V-shaped radial teeth 134 including planar side faces 136 and relatively sharp V-shaped crests 138 and relatively sharp V-shaped troughs 140 as described above in regard to the housing 20. As will be understood, the elements of the housing 120 shown in FIG. 5 have been numbered in the same sequence as the housing 20 described above and the elements function in the same way. However, this embodiment of the housing 120 may be formed of aluminum as opposed to high carbon steel.

FIG. 6 is a cross-sectional view of the housing 120 shown in FIG. 5 through view arrows 6-6 with the clutch plates 156 and 160 assembled in the housing. Although the clutch plates 156 and 160 may be identical to the clutch plates 56 and 60 described above with regard to FIG. 1, they are numbered in the 100 series for consistency with FIG. 5. Thus, the elements of the clutch assembly 120 are numbered in the same sequence as the clutch assembly 20 shown in FIG. 1 in the 100 series. However, in this embodiment, the internal surface 150 of the generally straight segments 146 is tapered outwardly toward the distal end 128 of the housing, providing improved flow of oil through the housing. As shown by arrows 182 in FIG. 6, the oil flows upwardly through the housing, through the longitudinal slots 148 and around the teeth 158 of the first plurality of clutch plates 156, providing significantly improved oil flow as compared to the prior art.

Having described preferred embodiments of the disclosed clutch assembly, it will be understood that various modifications may be made within the purview of the appended claims. The disclosed clutch assembly provides significant advantages over the known prior art, including larger contact faces of the clutch plate teeth to the internal teeth of the housing, providing greater torque with reduced likelihood of damage and improved oil flow through the housing reducing fires and damage to the transmission as described above.

What is claimed is:

1. A clutch assembly, comprising:
a housing having a generally cylindrical annular outer wall defined around a central axis;
an internal surface of said outer wall of said housing including a plurality of circumferentially spaced radial teeth each having a relatively sharp V-shaped crest and relatively sharp V-shaped trough and an included angle between adjacent teeth of about sixty degrees; and
a plurality of annular clutch plates nested within said annular outer wall of said housing having a plurality of circumferentially spaced external teeth each having a relatively sharp V-shared crest and a relatively sharp V-shaped trough with an included angle between adjacent teeth of about sixty degrees with the teeth of said clutch plates nested within the teeth of said housing.

2. The clutch assembly as defined in claim 1, wherein said internal surface of said outer wall of said housing includes generally straight segments between a plurality of adjacent teeth having a slot through said annular wall delivering oil through said annular wall.

3. The clutch assembly as defined in claim 2, wherein said slots extend generally parallel to said central axis.

4. The clutch assembly as defined in claim 2, wherein generally straight segments of said outer wall extend between crest portion of the radial teeth.

5. The clutch assembly as defined in claim 2, wherein said outer wall of said housing includes a plurality of said generally straight segments evenly circumferentially spaced about said outer wall.

6. The clutch assembly as defined in claim 4, wherein said internal surface of said outer wall of said housing includes at least three radial teeth between each of said relatively straight segments.

7. The clutch assembly as defined in claim 1, wherein said relatively sharp V-shaped crests and troughs of said teeth include a small rounded end surface.

8. The clutch assembly as defined in claim 1, wherein said plurality of annular clutch plates includes a plurality of thin annular metal plates having said plurality of external teeth and an annular fibrous plate between each of said annular metal plates.

9. The clutch assembly as defined in claim 2, wherein said annular clutch plates are formed of aluminum.

10. The clutch assembly as defined in claim 2, wherein said annular clutch plates include a fibrous outer layer and a metal core.

11. The clutch assembly as defined in claim 10, wherein said fibrous outer layer of said clutch plates include internal teeth.

12. An automotive clutch assembly, comprising:
a housing having an annular generally cylindrical outer wall defined about a central axis;
said outer wall of said housing having a plurality of circumferentially spaced triannular radial teeth each having planar side faces extending to an outer crest potion and an inner trough portion, said teeth having an included angle of about sixty degrees between adjacent teeth; and
said outer wall of said housing including a plurality of circumferentially space relatively straight segments between a plurality of said teeth each having a radial slot through said outer wall delivering lubricant through said outer wall.

13. The clutch assembly as defined in claim 12, wherein said planar side faces of said triannular teeth extend to a relatively sharp V-shaped crest and a relatively sharp V-shaped trough.

14. The clutch assembly as defined in claim 13, wherein said relatively sharp crests and troughs of said teeth include a small rounded end surface.

15. The clutch assembly as defined in claim 12, wherein said slot through said annular wall extends generally parallel to said central axis.

16. The clutch assembly as defined in claim 12, wherein said relatively straight segments extend between the crest portions of adjacent teeth.

17. The clutch assembly as defined in clam 12, wherein said relatively straight segments are evenly spaced about the periphery of said annular outer wall of said housing.

18. The clutch assembly as defined in claim 12, wherein the generally straight segments are evenly circumferentially spaced about said outer wall.

19. The clutch assembly as defined in claim 12, wherein the troughs of the teeth of said housing are tapered toward a distal end open end of said housing.

20. The clutch assembly as defined in claim 12, wherein the assembly includes a plurality of annular clutch plates nested within said outer wall of said housing each having a continuous plurality of external triangular radial teeth received and nested within said internal radial teeth of said housing and said straight segments between said teeth of said housing.
